(19) United States
(12) Patent Application Publication
(10) Pub. No.: US 2014/0244368 A1
(43) Pub. Date: Aug. 28, 2014

(54) ESTIMATING PRODUCT PROMOTION SALES LIFT

(71) Applicant: TARGET BRANDS, INC., Minneapolis, MN (US)

(72) Inventors: Hong Singhania, Prior Lake, MN (US); Rahul Seth, Bangalore (IN); Sanjay Sadasivan, Bangalore (IN); Maher Lahmar, Minneapolis, MN (US); Richard Mather, Minneapolis, MN (US)

(73) Assignee: Target Brands, Inc., Minneapolis, MN (US)

(21) Appl. No.: 13/779,269

(22) Filed: Feb. 27, 2013

(51) Int. Cl. G06Q 30/02

(52) U.S. Cl. CPC G06Q 30/0211
USPC 705/14.13

(57) ABSTRACT

Regular sales of a product during a period of time including at least one sales promotion for the product is estimated based on actual sales data for the product during the period of time. A correlation value for each pair of products is calculated. One or more products that are similar to a target product of are determined based on the correlation values of the similar products to the target product. Baseline sales of the target product during the period of time is calculated based on the estimated regular sales for each of the similar products. An incremental sales lift for the target product during the period of time is calculated based on actual sales data for the target product and the baseline sales of the target product during the period of time.

### TECHNICAL FIELD

This disclosure relates to systems and methods for managing and analyzing data related to the sale of one or more products in retail store outlets.

### BACKGROUND

in marketing and selling products across diverse geographical regions and through multiple retail outlet locations, multiple teams of personnel may be involved. Each team may establish their own promotional activities for the region and/or the retail outlet location(s) for which they are responsible. In many cases, retail personnel may design promotions based only on past experience and/or anecdotal evidence as a guide to the impact a particular promotion may have on product sales.

### SUMMARY

In general, this disclosure is directed to evaluating the effectiveness of different types of product promotions, including circulars and temporary price cuts, by calculating the sales lift attributable to the promotions, and also to evaluating the overall impact to a category of products by promotions on individual products in the category or group. One feature of the process outlined in this disclosure is the calculation of the baseline against which promotion sales are compared and based on which sales lift is determined. The process for calculating baseline sales dollars and/or unit sales includes establishing a baseline for a product based on sales data before and/or after promotion for that product and a number of other products that are determined to exhibit similar sales trends.

In one example, a method includes for each of a number of products in a product category of a retailer, estimating regular sales of the product during a period of time including at least one sales promotion for the product based on actual sales data for the product during the period of time. Regular sales of the product includes sales of a given product without any sales promotions for the given product. A correlation value for each pair of products is calculated. The correlation value is indicative of a similarity between the estimated regular sales for each product of the pair of products over the period of time. The method also includes determining one or more products that are similar to a target product of based on the correlation values of the similar products to the target product, calculating a baseline sales of the target product during the period of time based on the estimated regular sales each of the similar products, and calculating an incremental sales lift for the target product during the period of time based on actual sales data for the target product and the baseline sales of the target product during the period of time.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for estimating the sales lift of a product of a retailer on promotion.

FIG. 2 is a block diagram illustrating an example computing device that may estimate the sales lift of the product of the retailer on promotion.

FIG. 3 is a flow diagram illustrating an example method of estimating the sales lift of the product of the retailer on promotion.

FIG. 4 is a flow diagram illustrating another example method of estimating the sales lift of the product of the retailer on promotion.

FIG. 5 is a graph of actual unit sales of a target product for each week in a thirteen week time period and estimated baseline unit sales of the product during a one week promotion.

FIG. 6 is a graph of actual and estimated unit sales of six different products in a category for each week in a thirteen week, three-month time period.

### DETAILED DESCRIPTION

Examples according to this disclosure are directed to evaluating the effectiveness of different types of product promotions, including circulars and temporary price cuts, by calculating the sales lift attributable to the promotions. One feature of the process outlined in this disclosure is the calculation of the baseline against which promotion sales are compared and based on which sales lift is determined. The process for calculating baseline sales dollars and/or unit sales includes establishing a baseline for a product based on sales data before and/or after promotion for that product and for a number of other products that are determined to exhibit similar sales trends.

Many enterprises including, e.g., retailers employ a large number of sophisticated business analyses concerning products or other items to manage and improve sales revenues and profits. Retailers of consumer packaged goods (CPG) may, for example, attempt to determine the effect on sales of various types of promotional activities such as weekly circular advertisement promotions, temporary price cuts, and the like. The increase in sales of an item due to one or more product promotions may be referred to as sales lift. Such business analyses may be based, at least in part, on what is sometimes referred to as baseline sales, e.g. baseline sales units (e.g. volume) or baseline sales dollars (e.g. revenues or profits). Baseline sales may be defined as the amount of sales of a product or other item without any sales promotions for the item. The sales lift attributable to a sales promotion for an item sold by a retailer or other enterprise may be defined as the difference between the actual sales of the item during the promotion and baseline sales for the item. However, as baseline sales by definition cannot include sales of an item during a promotion, the calculation of lift depends on an estimation of baseline sales during time period the promotion occurs.

Many techniques have been employed to estimate baseline sales during promotional time periods, but prior techniques have often been prone to error. Because small errors in baseline sales estimates may cause large errors in analysis based thereon, a need exists for more accurate and efficient ways of determining baseline sales. As such, examples according to this disclosure are directed to determining the sales lift for a target item sold by a retailer attributable to a sales promotion employing an estimate of baseline sales determined based on sales data before and/or after promotion for the target item and for a number of other items that are determined to exhibit similar sales trends to the target item.

In one example, a method includes, for each item of a plurality of items sold by a retailer, estimating, with a computing device, non-promotional sales volume of the item during a period of time including a sales promotion for the item based on sales data for the item during the period of time, correlating, with the computing device, the non-promotional sales for each item of the plurality of items to one another, categorizing, with the computing device, one or more items of the plurality of items as similar to a select item of the plurality of items based on the correlation of the non-promotional sales of the one or more similar items to the non-promotional sales of the select item, estimating, with the computing device, baseline sales of the select item during the period of time based on the non-promotional sales fbr the select item and each of the one or more similar items, and calculating, with the computing device, a sales lift for the select item attributable to the sales promotion for the select item based on actual sales data for the select item and the estimated baseline sales of the select item during the time period.

In another example, a method includes, for each product of a plurality of products in a product category of a retailer, estimating, with a computing device, regular sales of the product during a period of time including at least one sales promotion for the product based on actual sales data for the product during the period of time. Regular sales include sales of a given product without any sales promotions for the given product. The method also includes calculating a correlation value for each pair of products of the plurality of products, wherein the correlation value is indicative of a similarity between the estimated regular sales for each product of the pair of products over the period of time, determining one or more products of the plurality of products similar to a target product of the plurality of products based on the correlation values of the one or more similar products to the target product, calculating a baseline sales of the target product during the period of time based on the estimated regular sales for the target product and each of the one or more similar products, and calculating an incremental sales lift for the target product during the time period based on actual sales data for the target product and the baseline sales of the target product during the time period.

In addition to improving the determination of baseline sales for a target product during a period of time including a promotion, examples according to this disclosure may provide advantages by estimating baseline sales for each product in each time period, e.g., each week, regardless of whether the product is on promotion in the week. Regular sales of a product in anon-promotion week (or other time period) may be impacted by sales of other products, e.g., other products in a common category that are on promotion. As such, estimating a baseline for products in non-promotion weeks can show the potential cannibalization or affiliation among items, and when rolled up to the product category level, the baseline can indicate the overall impact on the entire category by promoting a subset of products in the category.

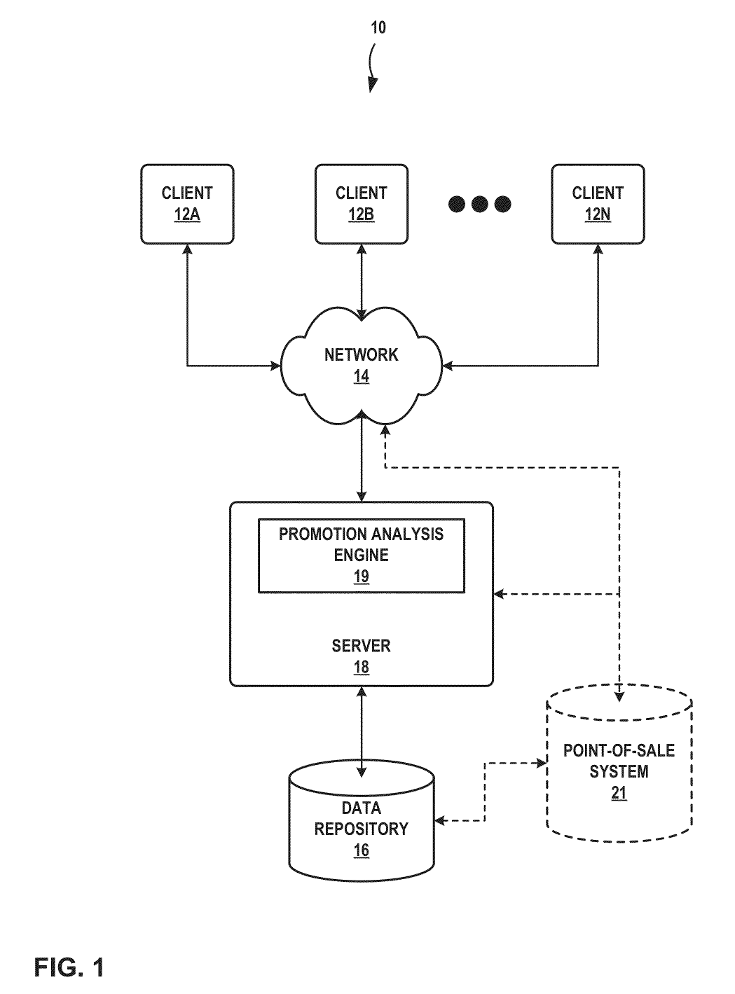

FIG. 1 is a block diagram illustrating example product promotion system (PPS) 10 including client computing devices 12A-12N (collectively “clients 12” or individually “client 12”), network 14, data repository 16, server 18, and point-of-sale (POS) system 21. Clients 12 are communicatively connected to data repository 16, server 18, and POS system 21 via network 14. Clients 12 and server 18 are configured to periodically communicate with one another over network 14 to track and store, e.g. in data repository 16, sales data associated with various products sold by a retailer, e.g. sales data retrieved from or communicated by POS system 21. Server 18 includes promotion analysis engine 19, which can be employed in conjunction with the product sales data to analyze the effect of various types of sales promotions on the sales of products of the retailer. In this manner, system 10, and other systems according to this disclosure including similar capabilities can be employed to calculate the sales lift for a product of the retailer that is attributable to a sales promotion.

In some examples, a retailer is an entity that provides services or retails merchandise through physical, tangible, non-Internet-based retail stores or through Internet-based stores. In the case of a retailer that sells products and services through physical, tangible, non-Internet-based retail stores, each store of the retailer can include retail floor space including a number of aisles. Each of the aisles can have shelf and/or rack space for displaying merchandise. In some stores, at least some of the aisles have end caps for displaying additional merchandise. Each of the stores includes one or more checkout lanes with cash registers at which customers can purchase merchandise. In some examples, the checkout lanes are staffed with cashiers.

Clients 12 can include any number of different portable electronic mobile devices, including, e.g., cellular phones, personal digital assistants (PDA's), laptop computers, portable gaming devices, portable media players, e-book readers, watches, as well as non-portable devices such as desktop computers. Clients 12 can include one or more input/output devices configured to allow user interaction with one or more programs configured to communicate with server 18 and promotion analysis engine 19. In one example, clients 12 include client computers from which users access and interact with promotion analysis engine 19. In one example, clients 12 run a web browser that accesses and presents a web application executed by server 18 or another device and allows a user to generate a report including sales transaction data for one or more items sold by the retailer. In another example, clients 12 execute an application outside of a web browser, e.g. an operating system specific application like a Windows application or Apple OS application that accesses and presents information processed promotion analysis engine 19 on server 18 or another device. In another example, one or more of clients 12 store and execute promotion analysis engine 19 locally.

Network 14 can include one or more terrestrial and/or satellite networks interconnected to provide a means of communicatively connecting clients 12 to data repository 16 and server 18. In one example, network 14 is a private or public local area network (LAN) or Wide Area Network (WANs). Network 14 can include both wired and wireless communications according to one or more standards and/or via one or more transport mediums. In one example, network 14 includes wireless communications according to one of the 802.11 or Bluetooth specification sets, or another standard or proprietary wireless communication protocol. Network 14 can also include communications over a terrestrial cellular network, including, e.g. a GSM (Global System for Mobile Communications), CDMA (Code Division Multiple Access), EDGE (Enhanced Data for Global Evolution) network. Data transmitted over network 14, e.g., from clients 12 to data repository 16 can be formatted in accordance with a variety of different communications protocols. For example, all or a portion of network 14 can be a packet-based, Internet Protocol (IP) network that communicates data from clients 12 to data repository 16 in Transmission Control Protocol/Internet Protocol (TCP/IP) packets, over, e.g., Category 5, Ethernet cables.

Data repository 18 and/or POS system 20 can each include, e.g., a standard or proprietary electronic database or other data storage and retrieval mechanism. In one example, data repository 18 and/or POS system 20 each include one or more databases, such as relational databases, multi-dimensional databases, hierarchical databases, object-oriented databases, or one or more other types of databases. Data repository 18 and/or POS system 20 can be implemented in software, hardware, and combinations of both. In one example, data repository 18 and/or POS system 20 include proprietary database software stored on one of a variety of storage mediums on a data storage server connected to network 14 and configured to store information associated with sales of products or other items at various locations of a retailer. Storage media included in or employed in cooperation with data repository 18 and/or POS system 20 can include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Data repository 16 and/or POS system 21 store information associated with sales of products and other items of the retailer. Examples of such information includes past actual sales transactions for the various products sold by the retailer at a number of locations, e.g., a number of stores in a number of different geographical locations. In one example, POS system 21 receives and processes sales data associated with customer transactions of the retailer at various locations of the retailer. Server 18 can periodically retrieve raw POS sales transaction data from POS system 21 and can store the data or process and then store the data in data repository 16. In another example, POS system 21 is configured to periodically “push” the sales data over network 14 to server 18 and/or data repository 16.

Server 18 includes promotion analysis engine 19, which is employed, as described below, to calculate the sales lift for a product of the retailer that is attributable to a sales promotion. Server 18 can be any of several different types of network devices. Examples of server 18 include a data processing appliance, web server, specialized media server, personal computer operating in a peer-to-peer fashion, or another type of network device. Promotion analysis engine 19 can be implemented in hardware, software, or a combination of both and can include one or more functional modules configured to execute various functions attributed to promotion analysis engine 19. Additionally, although example system FIG. 1 includes one server 18, other examples include a number of collocated or distributed servers configured to process sales and other types of data associated with products and other items sold by the retailer and stored in data repository 16 individually or in cooperation with one another.

Although data repository 16, server 18, and POS system 21 are illustrated as separate components in example system 10 of FIG. 1, in other examples the components are combined or each is distributed amongst more than one device. In one example, server 18 stores data repository 16 and control the repository to periodically retrieve sales data from POS system 21 over network 14. In another example, data repository 16 and/or POS system 21 are distributed among a number of separate devices, e.g. a number of database servers, and server 18 includes a number of co-located or distributed servers configured to operate and/or in cooperation with one another and with the various devices comprising data repository 16 and/or POS system 21.

Regardless of the particular configuration of system 10, or other example systems according to this disclosure, the system may be employed to calculate the sales lift for a product of the retailer that is attributable to a sales promotion. In one example, server 18 retrieves from POS system 21 or POS system 21 pushes actual sales transaction data to server 18 over network 14. The sales transaction data is received by server 18 periodically and stored in data repositories fir different periods of time, e.g., in blocks of one or more days, weeks, months, or years. Promotion analysis engine 19 executed by server 18 retrieves the sales transaction data for one or more products sold by the retailer and analyzes the sales data to calculate the sales lift for a product or products that is attributable to one or more sales promotions associated with the product(s).

In some examples, promotion analysis engine 19 analyzes sales data for a number of products that belong to the same product category for one or more time periods, e.g., one or more months. Products and other items sold by the retailer can be organized into categories of products. A product category can be a group of a number of products that share one or more attributes or are otherwise related to one another. In one example, the retailer organizes group apples, oranges, and bananas into a product category of “fresh fruit.” In another example, the retailer organizes shampoo, deodorant, and toothpaste into a product category of “personal hygiene.” Product categories may not necessarily include different types of products that share a similar purpose or function, as illustrated in the foregoing examples. In one example, product categories include different versions of the same type of item. In one such example, the retailer organizes different brands of toothpastes into a “toothpaste” category. In some examples, categories include items, the sales of which are interrelated and/or interdependent in one or more ways. For example, a category includes items, the customer demand for which exhibits affinity, substitution, cannibalism, or other interdependencies between different particular items in the category. In another example, a product category could be a group of products that are placed on the same store fixture.

In one example, promotion analysis engine 19 retrieves or simply references sales data stored on server 18 or data repository 16 for a plurality of products in a product category over a period of time. For example, promotion analysis engine 19 references sales data stored on data repository for 10 different brands of toothpaste for a three month time period including 13 weeks of sales. The time period for which the sales data is referenced by promotion analysis engine 19 can include at least one promotion. For example, the toothpaste sales data includes a week of sales of one or more of the toothpastes at a discounted price.

In one example, promotion analysis engine 19 estimates regular sales of each toothpaste in the category for the three month period including the one week a temporary price cut (TPC) or weekly circular promotion based on the actual sales data stored in data repository 16. “Regular” sales is used in this disclosure to refer to sales of a given product or other item without any sales promotions for the given product. Thus, regular sales for an item during non-promotional period of items can be equal to the actual sales of the item. Regular sales of the item during a promotion, however, may only be estimated based on actual sales data. For example, promotion analysis engine 19 estimates regular sales of a toothpaste during a promotional period for the toothpaste by interpolating between actual sales for the toothpaste the week before and the week after the week of the promotion. In another example, promotion analysis engine 19 estimates regular sales of a toothpaste during a promotional period for the toothpaste by interpolating between actual sales for the toothpaste for a number of weeks before and a number of weeks after the week of the promotion.

In one example, promotion analysis engine 19 compares the estimated regular sales of each of the toothpastes in the category to one another to determine, for each toothpaste, one or more other toothpastes that exhibit similar sales trends to a target (sometimes referred to as “select” toothpaste). For example, promotion analysis engine 19 correlates the estimated regular sales for each toothpaste in the category to one another to determine a correlation factor or value of each toothpaste to each other toothpaste in the category. The correlation factor or value can be a numerical value that represents the statistical similarity between the estimated regular sales of two or more items sold by a retailer.

In one example, promotion analysis engine 19 employs the correlation factors between the different toothpastes in the category to determine, for each toothpaste, one or more other toothpastes that exhibit sales trends above a threshold similarity to the target toothpaste. For example, promotion analysis engine 19 references the correlation factors for each toothpaste in the category to the target toothpaste. Promotion analysis engine 19 can then categorize one or more of the toothpastes having correlation factors above a threshold as similar to the target toothpaste.

As will be described in more detail below, sales data for the similar toothpastes are employed by promotion analysis engine 19 to calculate an estimated baseline sales for the target toothpaste. For example, promotion analysis engine 19 uses a weighted sum of the estimated regular sales for the similar toothpastes to estimate the baseline sales of the target toothpaste during the three month time period including the one week circular promotion. The weights associated with the similar toothpastes correspond to the degree to which each similar toothpaste is correlated to the target toothpaste. In one example, promotion analysis engine 19 uses the estimated baseline sales for the target toothpaste to determine the sales lift attributable to the circular promotion for the target toothpaste. For example, promotion analysis engine 19 uses the sales data stored in data repository 16 to calculate the difference between the actual sales of the target toothpaste during the one week circular promotion and the estimated baseline sales of the target product that week.

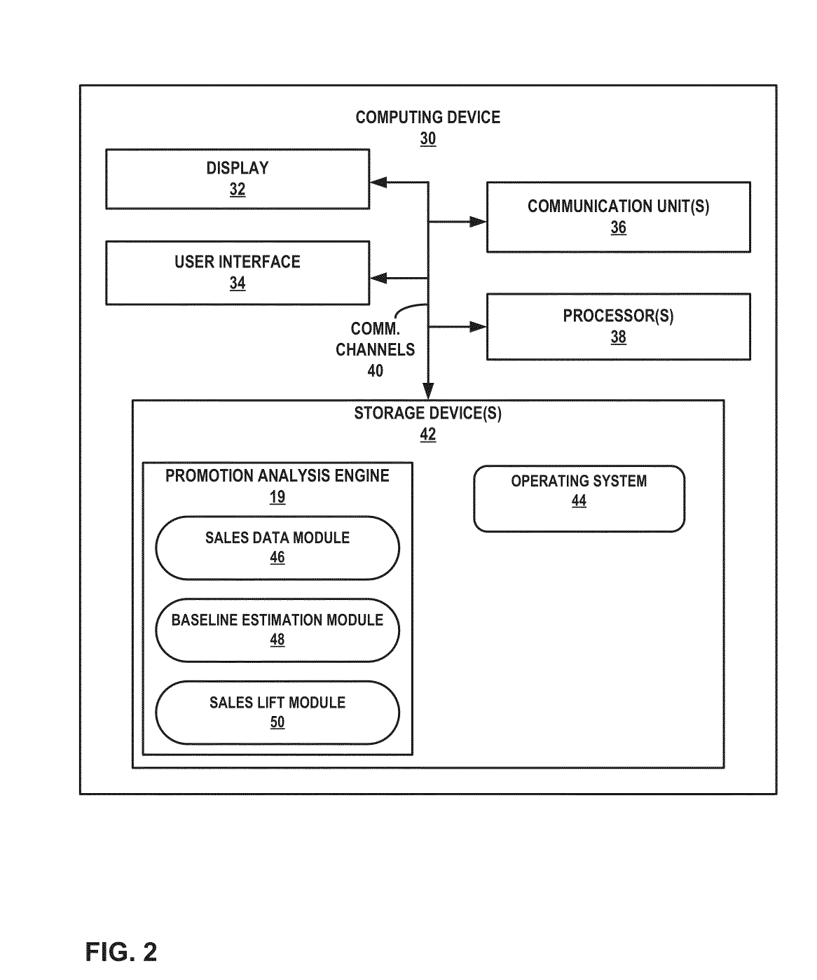

FIG. 2 is a block diagram illustrating an example computing device 30 that is configured to calculate the sales lift for a product or products that is attributable to one or more sales promotions associated with the product(s). FIG. 2 illustrates only one example of computing device 30, and many other examples of computing device 30 can be used in other instances. In addition, although discussed with respect to one computing device 30, one or more components and functions of computing device 30 can be distributed among multiple computing devices 30.

Computing device 30 is, in certain examples, be substantially similar to server device 18 of FIG. 1. As such, examples of computing device 30 include, but are not limited to, various types of network devices such as a data processing appliance, web server, specialized media server, personal computer operating in a peer-to-peer fashion, or another type of network device. Additional examples of computing device 30 include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others. In this manner, computing device 30 is substantially similar to one of client devices 12 of FIG. 1.

As shown in the example of FIG. 2, computing device 30 includes display 32, user interface 34, one or more communication units 36, one or more processors 38, and one or more storage devices 42. As illustrated, computing device 30 further includes promotion analysis engine 19 and operating system 44. Promotion analysis engine 19 includes sales data module 46, baseline estimation module 48, and sales lift module 50. Each of components 32, 34, 36, 38, and 42 are interconnected (physically, communicatively, and/or operatively) for inter-component communications. In some examples, communication channels 40 include a system bus, network connection, inter-process communication data structure, or any other channel for communicating data. As one example in FIG. 2, components 32, 34, 36, 38, and 42 are coupled by one or more communication channels 40. Promotion analysis engine 19, sales data module 46, baseline estimation module 48, sales lift module 50, and operating system 44 also communicate information with one another as well as with other components of computing device 30.

Display 32 can be a liquid crystal display (LCD), e-ink, organic light emitting diode (MID), or other display. Display 32 presents the content of computing device 30 to a user. For example, display 32 displays the output of promotion analysis engine 19 executed on one or more processors 38 of computing device 30, confirmation messages, indications, or other functions that may need to be presented to a user. In some examples, display 32 provides some or all of the functionality of a user interface of computing device 30. For instance, display 32 can be a touch-sensitive and/or presence-sensitive display that can display a graphical user interface (GUI) and detect input from a user in the form of user input gestures using capacitive or inductive detection at or near the presence-sensitive display.

User interface 34 allows a user of computing device 30 to interact with computing device 30. Examples of user interface 34 include, but are not limited to, a keypad embedded on computing device 30, a keyboard, a mouse, a roller ball, buttons, or other devices that allow a user to interact with computing device 30. In some examples, computing device 30 does not include user interface 34, and the user interacts with computing device 30 with display 32 (e.g., by providing various user gestures). In some examples, the user interacts with computing device 30 with user interface 34 and display 32.

Computing device 30, in some examples, also includes one or more communication units 36. Computing device 30, in one example, utilizes one or more communication units 36 to communicate with external devices (e.g., clients 12 of FIG. 1) via one or more networks, such as one or more wireless networks, one or more cellular networks, or other types of networks. One or more of communication units 36 can be a network interface card, such as an Ethernet card, an optical transceiver, a radio frequency transceiver, or any other type of device that can send and receive information. Other examples of such network interfaces include Bluetooth, 3G and WiFi radio computing devices as well as Universal Serial Bus (USB).

One or more processors 38 (hereinafter “processors 38”), in one example, are configured to implement functionality and/or process instructions for execution within computing device 30. For example, processors 38 are capable of processing instructions stored at one or more storage devices 42, which include, in some examples, instructions for executing functions attributed to promotion analysis engine 19 and the modules thereof. Examples of processors 38 include any one or more of a microprocessor, a controller, a digital signal processor (DSP), an application specific integrated circuit (ASIC), a field-programmable gate array (FPGA), or equivalent discrete or integrated logic circuitry.

One or more storage devices 42 (hereinafter “storage devices 42”) can be configured to store information within computing device 30 during operation. Storage devices 42, in some examples, are described as a computer-readable storage medium. In some examples, storage devices 42 include a temporary memory, meaning that a (primary purpose of one or more storage devices 42 is not long-term storage. Storage devices 42 are, in some examples, described as a volatile memory, meaning that storage devices 42 do not maintain stored contents when the computer is turned off. Examples of volatile memories include random access memories (RAM), dynamic random access memories (DRAM), static random access memories (SRAM), and other forms of volatile memories known in the art. In some examples, storage devices 42 are used to store program instructions for execution by one or more processors 38. Storage devices 42, for example, are used by software or applications running on computing device 30 (e.g., promotion analysis engine 19) to temporarily store information during program execution.

Storage devices 42, in some examples, also include one or more computer-readable storage media. Storage devices 42 can be configured to store larger amounts of information than volatile memory. Storage devices 42 can further be configured for long-term storage of information. In some examples, storage devices 42 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

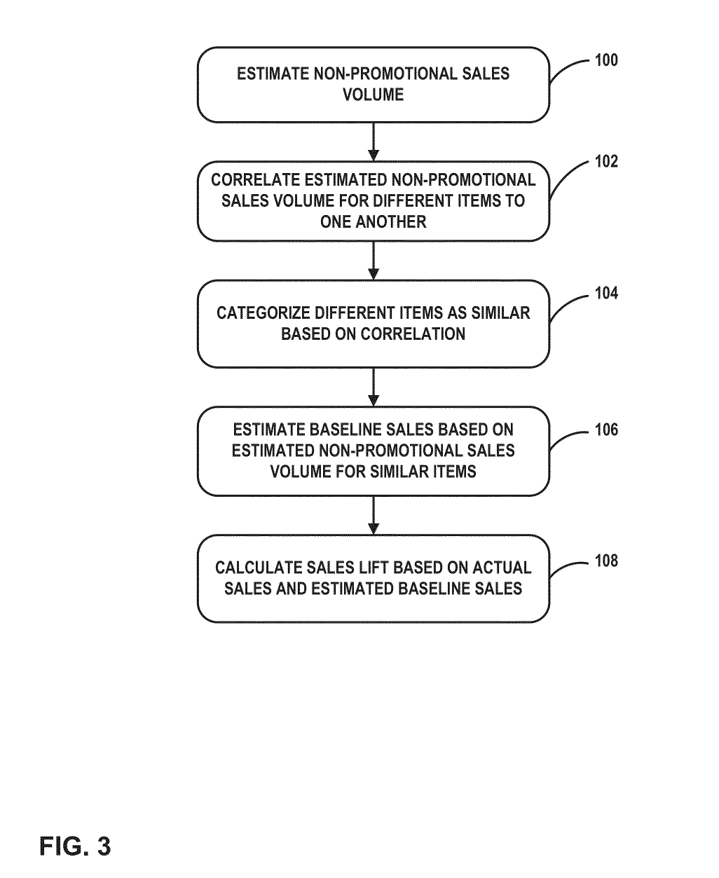

As illustrated in FIG. 2, computing device 30 includes promotion analysis engine 19. Promotion analysis engine 19 includes sales data module 46, baseline estimation module 48, and sales lift module 50. Sales data module 46 of promotion analysis engine 19 are configured to retrieve, receive, or otherwise reference actual sales transaction data corresponding to sales of products or other items at a number of different locations of a retailer. Sales data module 46, for example, retrieves sales data from a data repository like data repository 16 of FIG. 1. Baseline estimation module 48 of promotion analysis engine 19 is configured to estimate baseline sales for a target product of a retailer during a time period including at least one sales promotion. For example, baseline estimation module 48 uses a weighted sum of estimated regular sales for the target product and other products with similar sales trends to the target product to estimate the baseline sales of the target product during a time period including one or more promotions. Sales lift module 50 is configured to calculate the sales lift for a target product that is attributable to one or more sales promotions associated with the target product based at least in part on the estimated baseline sales for the target product. The functions of sales data module 46, baseline estimation module 48, and sales lift module 50 of promotion analysis engine 19 are described in greater detail with reference to FIGS. 3-5 below.

Although shown as separate components in FIG. 2, in some examples, one or more of promotion analysis engine 19, sales data module 46, baseline estimation module 18, and sales lift module 50 can be part of the same module. In some examples, one or more of promotion analysis engine 19, sales data module 46, baseline estimation module 48 and sales lift module 50 are formed in a common hardware unit. In some instances, one or more of promotion analysis engine 19, sales data module 46, baseline estimation module 48, and sales lift module 50 are software and/or firmware units that are executed on processors 38. In general, the modules of promotion analysis engine 19 are presented separately for ease of description and illustration. However, such illustration and description should not be construed to imply that these modules of promotion analysis engine 19 are necessarily separately implemented, but can be in some examples.

Additionally, although the foregoing examples have been described with reference to promotion analysis engine 19 including sales data module 46, baseline estimation module 48, and sales lift module 50, in other examples such function/processing engines or other mechanisms configured to operate in accordance with the disclosed examples can be physically and/or logically differently arranged. For example, promotion analysis engine 19 includes a baseline estimation module and sates module, in which one or both of the two modules are configured to retrieve or otherwise reference sales data, e.g., retrieved by computing device 30 from a data repository like data repository 16 of FIG. 1. A wide variety of other logical and physical arrangements are possible in order to implement the functionality attributed to the example of promotion analysis engine 19 illustrated FIGS. 1 and 2.

Computing device 30 includes operating system 44. Operating system 44, in some examples, controls the operation of components of computing device 30. For example, operating system 44, in one example, facilitates the communication of promotion analysis engine 19 with processors 38, display 32, user interface 34, and communication units 36.

Computing device 30 can include additional components not shown in FIG. 2. For example, computing device 30 can include a battery to provide power to the components of computing device 30. Similarly, the components of computing device 30 may not be necessary in every example of computing device 30. For instance, in certain examples computing device 30 may not include display 32.

FIG. 3 is a flowchart illustrating an example method of determining the sales lift for a product or products that is attributable to one or more sales promotions associated with the product(s). The method of FIG. 3 includes estimating non-promotional sales volume of a target item during a period of time including a sales promotion for the target item based on actual sales data for the target item during the period of time (100), correlating estimated non-promotional sales for each of a plurality of other items during the time period to the target item (102), categorizing one or more of the other items as similar to the target item based on the correlation of the non-promotional sales of the plurality of other items to the non-promotional sales of the target item (104), estimating baseline sales of the target item during the period of time based on sales for each of the one or more other items categorized as similar to the target item (106), and calculating sales lift for the target item attributable to the sales promotion for the target item based on the actual sales data for the target item and the estimated baseline sales of the target item during the time period (108).

The example method of FIG. 3 illustrates generally the manner in which examples according to this disclosure function to determine the sales lift for a product or products that is attributable to one or more sales promotions associated with the product(s). The functions of the method of FIG. 3 can be carried out by a variety of computing devices, including, e.g., by promotion analysis engine 19 of computing device 30 of FIG. 2. For example, Sales data module 46 of promotion analysis engine 19 is configured to retrieve, receive, or otherwise reference actual sales transaction data corresponding to sales of products or other items at a number of different locations of a retailer. Sales data module 46, for example, retrieves sales data from a data repository like data repository 16 of FIG. 1, which stores sales transaction data that has been captured by POS system 21.

Baseline estimation module 48 of promotion analysis engine 19 is configured to estimate baseline sales for a target product of a retailer during a time period including at least one sales promotion. For example, baseline estimation module 48 uses a weighted sum of estimated regular sales for the target product and other products with similar sales trends to the target product to estimate the baseline sates of the target product during a time period including one or more promotions. In the context of the example method of FIG. 3, baseline estimation module 48 estimates non-promotional sales volume of an item during a period of time including a sales promotion for the target item based on actual sales data for the target item during the period of time (100). In one example, this estimation is executed iteratively by baseline estimation module 48 for a plurality of items that below to a category of items sold by a retailer.

In one example, baseline estimation module 48 of promotion analysis engine 19 also correlates non-promotional sales for each of a plurality of items during the time period to a target item (102). In one example, baseline estimation module 48 statistically correlates the trend of the non-promotional sales of each of the items to the target item to determine the degree to which the non-promotional sales trends of the items are similar to the non-promotional sales trend of the target item. Based on the correlation, baseline estimation module 48 also categorizes one or more of the items as similar to the target item (104). Additionally, baseline estimation module 48 of promotion analysis engine 19 estimates the baseline sales of the target item during the period of time based on the non-promotional sales for the target item and each of the one or more other items categorized as similar to the target item (106). For example, baseline estimation module 48 uses a weighted sum of estimated regular sales for the target product and other products with similar sales trends to the target product to estimate the baseline sales of the target product during a time period including one or more promotions.

After the baseline sales has been estimated by baseline estimation module 48, sales lift module 50 calculates the sales lift, e.g. the incremental increase in sales for the target item attributable to the sales promotion for the target item based on the actual sales data for the target item and the estimated baseline sales of the target item during the time period (108). For example, sales lift module 50 calculates the sales lift of the target item as the difference between the actual sales of the target item and the estimated baseline sales of the target item during the week of the promotion.

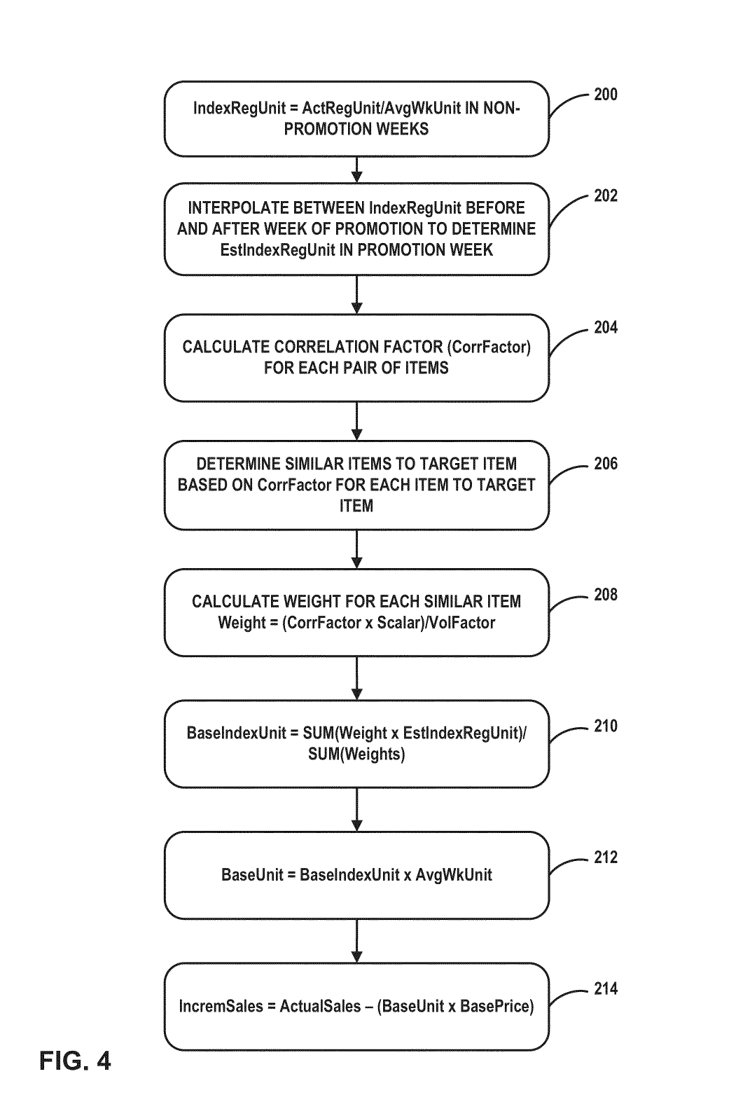

FIG. 4 is a flowchart illustrating another example method according to this disclosure of determining the sales lift for a product that is attributable to a sale promotion associated with the product. As with the method of FIG. 3, the method of FIG. 4 may be carried out by a variety of computing devices, including, e.g., by promotion analysis engine 19 of computing device 30 of FIG. 2. As has been alluded to above, one of the goals of examples according to this disclosure is to evaluate the effect of sales promotions on the sales of products of a retailer. One way to evaluate sales promotions is to estimate the incremental increase (or decrease) in sales of a product during a promotion. Such sales lift estimations can be executed for one product, a large number of products, or even all of the products sold by a retailer at one or more locations. In some cases, sales lift estimations are executed for a number of products belonging to a common category and which are promoted during the same time period, e.g., during one week in a month or a quarter.

The example method of FIG. 4 can be employed to estimate the sales lift for each product in a category and also calculate the total category sales lift. The sales lift calculation is a relatively straight forward calculation of the difference between the actual sales of an item during a promotion and an estimate of what the item sales would have been for that particular time period if the promotion did not occur, or, in other words, if the item was not on promotion. The actual sales can be tracked and stored electronically by a retailer using, e.g. computing system such as POS system 21 described with reference to FIG. 1. The baseline sales, however, can be challenging to accurately and efficiently estimate. In the example of FIG. 4, therefore, functions 200-212 are all executed in order to estimate the baseline number of units of an item that would have been sold during a promotion week if the item was not on promotion. Once the baseline sales have been estimated, in this case, the baseline number of units, sales lift for the target item can be quickly determined as the difference between the actual promotional sales and the estimated baseline sales.

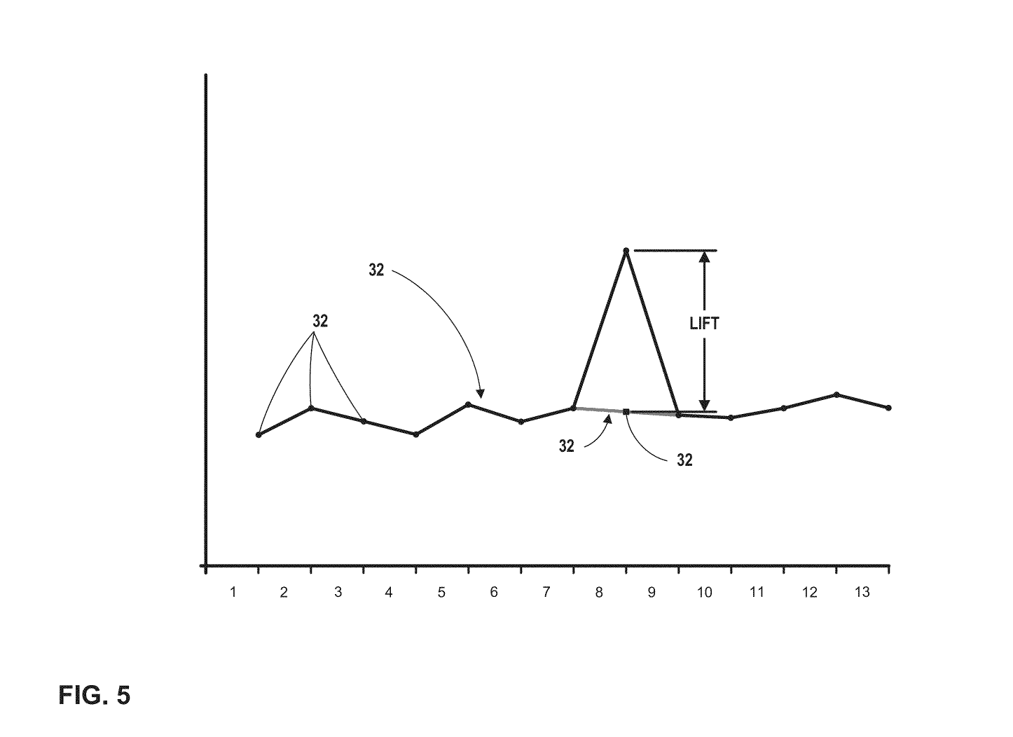

The calculation of incremental sales lift is illustrated in the example of FIG. 5, which is a graph of actual unit sales 300 of a target product for each week in a thirteen week, three-month time period and baseline unit sales 302 during a one week promotion in week 9 of the thirteen week period. As illustrated in the example of FIG. 5, the sales lift for the target product is the difference between the estimated baseline unit sales 304 in week nine and the actual unit sales 306 of the target product during the promotion.

In some examples according to this disclosure, the sales lift is determined for each of the items in the category in the manner illustrated in FIG. 4. Based on the incremental sales lift for each of the items in the category, the total category sales lift is then be determined.

In one example of the method of FIG. 4, sales data module 46 of promotion analysis engine 19 retrieves sales data stored on server 18 or data repository 16 for a plurality of products in a product category over a period of three months including thirteen weeks. The actual sales data includes sales transaction data for the products during the three month period of time, which indicates the actual number of units and sales revenue of each transaction. The sales data includes sales across one or more store locations for the retailer of the products. In one example, the time period for which the sales data is retrieved by sales data module 46 includes a promotion. Additionally, in one example, the promo ion lasts for one week of the thirteen week, three month period and of the products in the category are on promotion during the same week. In other examples, only one or some of the products in a category is on sale in any given week.

Baseline estimation module 48 employs the actual sales data retrieved by sales data module 46 to determine an estimate of the regular sales of the products in the category during the non-promotional and promotional weeks in the three month period of time. In some examples, it is convenient to index product sales values against one or more parameters like average sales. For example, regular sales of a product in one week of the thirteen week, three month period of time is indexed to the average weekly sales of the product over all thirteen weeks. In FIG. 4, baseline estimation module 48 determines the indexed regular unit sales (IndexRegUnit) of a product in each week in the three month period that does not include the one week promotion by indexing the actual regular unit sales of the product during the non-promotional weeks to the average weekly unit sales, AvgWkUnit, of the product over the weeks when it is not on promotion, e.g. has regular sales. Thus, in the twelve non-promotional weeks of the three-month period of time, the regular sales of the product is equal to the actual regular sales and the IndexRegUnit=RegUnit/AvgWkUnit (200). In one example, baseline estimation module 48 iteratively repeats the calculation of IndexRegUnit for each product in the category such that the calculation can be expressed as:

IndexRegUnit(i₁₋ₙ,w₁₋ₘ)=ActRegUnit(i₁₋ₙ,w₁₋ₘ)/AvgWkUnit(i₁₋ₙ)

where:

are products 1-n in the category,

w₁₋ₘ are 1-m number of weeks in the three-month period of time, and

all of the weeks 1-m are non-promotional weeks.

As noted above and illustrated by the determination of IndexRegUnit (200) in the example of FIG. 4, regular sales for an item during non-promotional sales periods thr the item is equal to the actual sales of the item. However, regular sales of an item during a promotion can only be estimated based on actual sales data. Thus, in order to determine/estimate the indexed regular unit sales of each product in the category for the whole three month period of time including the week of the category promotion, baseline estimation module 48 estimates the indexed regular unit sales (EstIndexRegUnit) of a product during the one promotional week. In one example, baseline estimation module 48 interpolates between the IndexRegUnit sates of a product in one or more of the weeks before and after the week of the promotion to determine EstIndexRegUnit in the promotional week (202).

For example, the promotion week occurs on week 8 of the thirteen week, three-month period of time. In one such example, baseline estimation module 48 fits a curve to the indexed regular unit sales of a product during weeks 1-7 and 9-13 to estimate the indexed regular unit sales during the promotional week 8. In another example, baseline estimation module 48 applies one or more of a number of regression analyses to the indexed regular unit sales of a product during weeks 1-7 and 9-13 to estimate the indexed regular unit sales during the promotional week 8. In another example, baseline estimation module 48 performs a linear interpolation between the indexed regular unit sales of a week 7 and week 9 to determine EstIndexRegUnit during week 8.

After determining the indexed regular unit sales of the products in the non-promotional and promotional weeks of the time period, baseline estimation module 48 is configured to determine one or more products in the category that exhibit sales trends during the time period that are similar to a target product. In the context of the example of FIG. 4, baseline estimation module 48 calculates a correlation factor (CorrFactor) for each unique pair of products in the category. The correlation factor is indicative of a similarity between the regular sales for each product of the pair of products over the period of time.

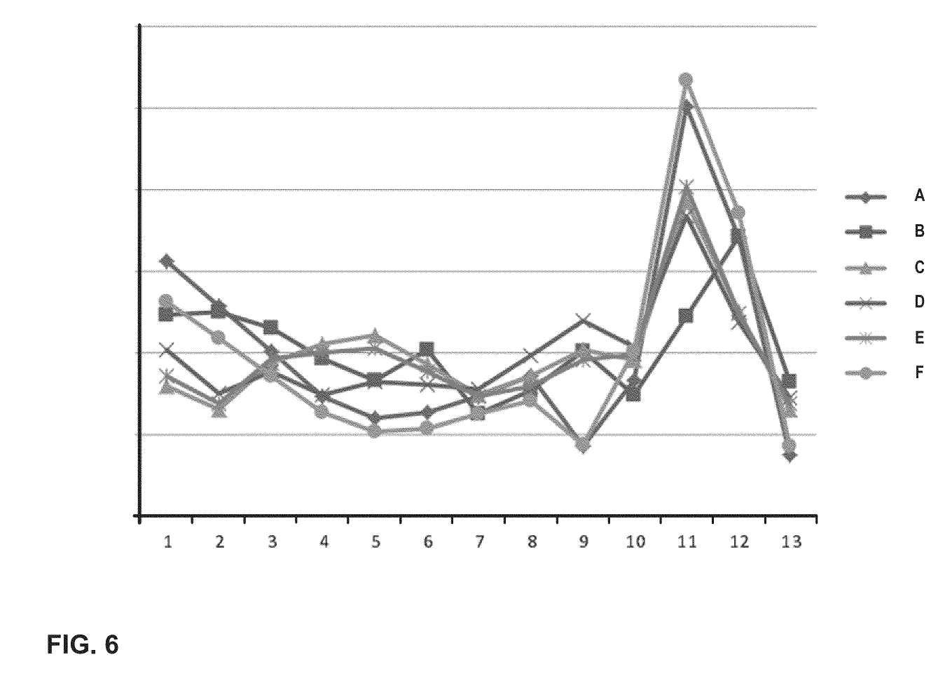

FIG. 6 is a graph of actual and estimated unit sales of six different products for each week in a thirteen week, three-month time period. The unit sales spikes for products A and C-F in week 11 and for product B correspond to promotional weeks for each of the respective products. In one example, baseline estimation module 48 is configured to statistically correlate the sales of products B-F to product A. In one example, baseline estimation module 48 employs a Pearson Correlation Calculation to correlate the sales of products B-F to product A. In other examples, baseline estimation module 48 can employ other statistical correlation techniques to correlate the sales of products B-F to product A. The correlation can be based on actual sales or regular sales (e.g. including actual regular sates during non-promotional weeks and estimated regular sales during promotional weeks), either of which can be indexed, e.g., against average weekly sales in the manner described above.

In one example, baseline estimation module 48 expresses the similarity between the sales of products in the category and the target product as a percentage correlation. For example, referring again to products A-F in FIG. 6, the sales trend of product F over the 13 week time period is most closely correlated to the sales trend of product A with a correlation of approximately % 97.8. In contrast, the sales trend of product B over the 13 week time period is the least correlated to the sales trend of product A with a correlation of approximately % 65.9. One of the differences between product B and product A that, at least in part, reduces the correlation between the sales of the two products is that the promotion for product B occurs in week 12, while the promotion for product A and the rest of the products CF occurs in week 11.

Referring again to the example method of FIG. 4, baseline estimation module 48 determines one or more products that are similar to the target product based on the correlation factor, CorrFactor, of each product to the target product (206). For example, baseline module 48 analyzes the correlation factors of each of the products to the target product to find one or more products that have correlation values to the target product that are greater than or equal to a threshold correlation value. Various threshold correlation values may be employed in examples according to this disclosure. In one example, an initial threshold correlation is set to 0.8, and if less than 5 similar products are found at this threshold, the correlation threshold is dynamically lowered. In one example, the initial threshold correlation is 0.8 and, if less than 5 similar products are found, the threshold is lowered to 0.6. The correlation threshold and the requirement for the number of similar items are parameters that can be adjusted.

In the example of products A-F in FIG. 6, product C has a correlation factor of % 68.2 to product A. Product D has a correlation factor of % 75.6 to product A. Product E has a correlation factor of % 75.6 to product A. In one example, baseline module 48 analyzes the correlation factors of each of the products B-F to target product A to find one or more products that have correlation values to the target product that are greater than or equal to a threshold correlation value of approximately % 75. Thus, in the example of FIG. 6, baseline estimation module 48 determines that products D, E, and F are similar to product A.

When the estimated indexed regular sales of the similar products are used to determine baseline sales for the target product, the similar products may not all be treated equally in the calculation. One reason for weighting the similar items in the baseline sales calculation is that the products may have a substantially different sates volume than the target product. Thus, in one example, baseline estimation module 48 calculates a weight for each similar product that is indicative of both the degree of sales trend correlation between the similar product and the target product and the degree of similarity between the absolute sales volumes of the two products. In the example of FIG. 4, baseline estimation module calculates the weights for each of the similar products according to the following formula.

Weight(i₁₋ₙ)=CorrFactor(i,j)*Scalar/VolFactor

where:

j=the target product,

i₁₋ₙ=similar products 1-n, and

Scalar=constant that scales up or down the absolute value of Weight (i₁₋ₙ, j)

VolFactor=|AvgWkUnit(i)−AvgWkUnit(j)|

Once baseline estimation module 48 has the weighted correlations of the similar products to the target product and the estimated indexed regular sales of the one or more similar products, module 48 calculates an estimate of the baseline unit sales for the target product (210), In one example, baseline estimation module 48 first calculates an estimated indexed baseline unit sales for the target product over the time period according to the following formula.

BaseIndexUnit(j,w₁₋ₙ)=SUM[Weight(i₁₋ₙ)*EstIndexRegUnit(i₁₋ₙ,w₁₋ₘ)]/SUM[Weight(i₁₋ₙ)]

where:

j=the target product,

i=similar products 1-n,

w₁₋ₘ=weeks 1-m in the time period, and

Baseline estimation module 48 can also determine the non-indexed baseline unit sales for the target product (212). In one example, baseline estimation module 48 calculates the baseline unit sales for the target product based on the estimated indexed baseline unit sales and the average weekly unit sales, AvgWkUnit, for the product across all weeks in the time period. In other words, baseline estimation module 48 calculates the baseline unit sales for the target product according to the following formula.

BaseUnit(j,w₁₋ₙ)=BaseIndexUnit(j,w₁₋ₙ)*AvgWkUnit(j)

where:

j=the target product,

w₁₋ₙ=weeks 1-n in the time period

As noted above, the sales lift calculation for a target product is a relatively straight forward calculation of the difference between the actual sales of the product during a promotion and an estimate of what the product sales would have been for that particular time period if the promotion did not occur, or, in other words, if the item was not on promotion. The estimate of what the product sales would have been for the time period if the promotion did not occur, in examples according to this disclosure, is denoted as the estimated baseline sales of the product. Thus, the sales lift calculation is executed by sales lift module 50 of computing device 30 by determining the difference between the actual sales of the target product and the estimated baseline sales of the product during the promotion week. In the example of FIG. 4, incremental sales lift, IncremSales (j), of the target product is calculated according to the following formula.

IncremSales(j,wₚ)=ActualSales(j,wₚ)−[BaseUnit(j,wₚ)*RegPrice(j)]

where:

ActualSales (j, wₚ)=actual sales dollars for target product during the promotion week

j=target product,

wₚ=promotional week during time period

RegPrice(j)=price of the target product without any promotion

As noted above, in some examples according to this disclosure, the sales lift for entire category of products is determined based on the individual estimated baseline unit sales and/or the sales lift of each of the items in the category. In one example, the category sales lift is calculated as the sum of the sales lifts of each of the items in the category. In another example, the category sales lift is expressed as a percentage increase in either sales units or sales dollars. For example, the actual sales units and the estimated baseline units during a promotional week of each of the items in the category are summed together to determine a category actual sales units and a category estimated baseline units. In this case, the percentage units incrementality for the category are expressed as equal to the category actual sales units minus the category estimated baseline units divided by the category estimated baseline units. In another example, the actual sales dollars and the estimated baseline dollars during a promotional week of each of the items in the category are summed together to determine a category actual sales dollars and a category estimated baseline dollars. In this case, the percentage dollars incrementality for the category is expressed as equal to the category actual sales dollars minus the category estimated baseline dollars divided by the category estimated baseline dollars.

The techniques described in this disclosure can be implemented, at least in part, in hardware, software, firmware or any combination thereof. For example, various aspects of the described techniques can be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware can also perform one or more of the techniques of this disclosure.

Such hardware, software, and firmware can be implemented within the same device or within separate devices to support the various operations and functions described in this disclosure. In addition, any of the described units, modules or components can be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units can be performed by separate hardware or software components, or integrated within common or separate hardware or software components.

The techniques described in this disclosure can also be embodied or encoded in a computer-readable medium, such as a computer-readable storage medium, containing instructions. Instructions embedded or encoded in a computer-readable medium can cause a programmable processor, or other processor, to perform the method, e.g., when the instructions are executed. Computer readable storage media includes random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In some examples, computer-readable storage media includes non-transitory media. The term “non-transitory” may indicate that the storage medium is not embodied in a carrier wave or a propagated signal. In certain examples, a non-transitory storage medium can store data that can, over time, change (e.g., in RAM or cache).

Various examples have been described. These and other examples are within the scope of the following claims.

1. A method comprising:
for each product of a plurality of products in a product category of a retailer, estimating, with a computing device, regular sales of the product during a period of time including at least one sales promotion for the product based on actual sales data for the product during the period of time, wherein regular sales comprise sales of a given product without any sales promotions for the given product;
calculating, with the computing device, a correlation value for each pair of products of the plurality of products, wherein the correlation value is indicative of a similarity between the estimated regular sales for each product of the pair of products over the period of time;
determining, with the computing device, one or more products of the plurality of products similar to a target product of the plurality of products based on the correlation values of the one or more similar products to the target product;
calculating, with the computing device, a baseline sates of the target product during the period of time based on the estimated regular sates for each of the one or more similar products; and
calculating, with the computing device, an incremental sales lift thr the target product during the period of time based on actual sales data for the target product and the baseline sales of the target product during the period of time.

2. The method of claim 1, wherein the target product comprises a first target product, and further comprising:
determining, with the computing device, one or more products of the plurality of products similar to a second target product of the plurality of products based on the correlation values of the one or more similar products to the second target product;
calculating, with the computing device, a weighting factor for each of the one or more similar products based on the correlation values of each of the one or more similar products to the second target product;
calculating, with the computing device, a baseline sales of the second target product during the period of time based on the weights for each of the one or more similar products and the estimated regular sales for the second target product and each of the one or more similar products; and
calculating, with the computing device, the incremental sales lift for the second target product during the period of time based on actual sales data for the second target product and the baseline sales of the second target product during the period of time.

3. The method of claim 1, wherein, for each product of the plurality of products in the product category of the retailer, estimating, with the computing device, regular sales of the product during the period of time comprises estimating regular sales of the product during the at least one promotion during the period of time based on actual sales data for the product sometime before and sometime after the at least one promotion during the period of time.

4. The method of claim 3, wherein the period of time comprises a plurality of weeks and wherein each promotion of the at least one promotion lasts for one week, and wherein estimating regular sales of the product during the at least one promotion during the period of time based on actual sales data for the product sometime before and sometime after the at least one promotion during the period of time comprises estimating regular sales of the product during the week of each promotion of the at least one promotion during the period of time by interpolating between actual sales data for the product the week before and the week after the week of each promotion of the at least one promotion during the period of time.

5. The method of claim 1, wherein calculating, with the computing device, the correlation value for each pair of products of the plurality of products comprises comparing the estimated regular sales for each product of the pair of products to one another to determine the similarity between the estimated regular sales for each product of the pair of products over the period of time.

6. The method of claim 1, wherein determining, with the computing device, the one or more products of the plurality of products similar to the target product of the plurality of products based on the correlation values of the one or more similar products to the target product comprises analyzing correlation values of each of the products of the plurality of products to the target product to find one or more products having correlation values to the target product that are greater than or equal to a threshold correlation value.

7. The method of claim 1, further comprising calculating, with the computing device, a weighting factor for each of the one or more similar products based on the correlation values of each of the one or more similar products to the target product.

8. The method of claim 7, wherein calculating, with the computing device, the weighting factor for each of the one or more similar products comprises calculating the weighting factor for each of the one or more similar products based on the correlation values of each of the one or more similar products to the target product and based on a volume factor for each of the one or more similar products, wherein the volume factor is representative of the difference between a sales volume for each of the one or more similar products and a sales volume of the target product.

9. The method of claim 8, wherein calculating the weighting factor for each of the one or more similar products based on the correlation values of each of the one or more similar products to the target product and based on the volume factor for each of the one or more similar products comprises:
multiplying a constant by the inverse of the absolute value of the difference between a sales volume for each of the one or more similar products and a sales volume for the target product to determine the volume factor for each of the one or more similar products; and
multiplying the correlation value of each of the one or more similar products to the target product by the volume factor for each of the one or more similar products to determine the weighting factor for each of the one or more similar products.

10. The method of claim 7, wherein calculating, with the computing device, the baseline sales of the target product during the period of time comprises calculating the baseline sales of the second target product during the period of time based on the weights for each of the one or more similar products and the estimated regular sales for the second target product and each of the one or more similar products.

11. The method of claim 1, wherein calculating, with the computing device, the baseline sales of the target product during the period of time comprises:
for each of the one or more similar products, calculating a product of the weighting factor and the estimated regular sales for the product;
summing the products of the weighting factors and the estimated regular sales for each of the one or more similar products;
summing the weighting factors for each of the one or more similar products; and
dividing the sum of the products of the weighting factors and the estimated regular sales for each of the one or more similar products by the sum of the weighting factors for each of the one or more similar products.

12. The method of claim 1, wherein calculating, with the computing device, the incremental sales lift for the target product during the period of time comprises calculating the difference between the actual sales of the target product during the at least one promotion during the period of time and the baseline sales of the target product during the at least one promotion during the period of time.

13. A computing device, comprising:
at least one computer-readable storage device, wherein the at least one computer-readable storage device is configured to store actual sales data for a plurality of items sold by a retailer; and
at least one processor configured to access information stored on the at least one computer-readable storage device and to perform operations comprising:
estimating non-promotional sales volume of a target item during a period of time including a sales promotion for the target item based on actual sales data for the target item during the period of time;
correlating non-promotional sales for each of a plurality of other items during the period of time to the target item;
estimating baseline sales of the target item during the period of time based on the non-promotional sales of one or more of the other items comprising a threshold non-promotional sales correlation to the target item; and
calculating sales lift for the target item attributable to the sales promotion for the target item based on the actual sales data for the target item and the estimated baseline sales of the target item during the period of time.

14. The computing device of claim 13, wherein estimating the non-promotional sales volume of the target item during the period of time comprises estimating non-promotional sales of the target item during the promotion during the period of time based on actual sales data for the target item sometime before and sometime after the promotion during the period of time.

15. The computing device of claim 14, wherein the period of time comprises a plurality of weeks and wherein the promotion lasts for one week, and wherein estimating the non-promotional sales of the target item during the promotion during the period of time based on actual sales data for the target item sometime before and sometime after the promotion during the period of time comprises estimating non-promotional sales of the target item during the week of the promotion during the period of time by interpolating between actual sales data for the target item in the weeks before and the weeks after the week of the promotion during the period of time.

16. The computing device of claim 13, wherein correlating the non-promotional sales for each of a plurality of other items during the period of time to the target item comprises calculating a correlation value for each of the other items to the target item, wherein the correlation value is indicative of a similarity between an estimate of non-promotional sales for each the other items and the estimated non-promotional sales of the target item during the period of time.

17. The computing device of claim 16, wherein estimating baseline sales of the target item during the period of time comprises analyzing the correlation values of each of the other items to the target item to find one or more items of the other items having correlation values to the target item that are greater than or equal to a threshold correlation value.

18. The computing device of claim 17, further comprising calculating a weighting factor for each of the one or more of the other items comprising the threshold non-promotional sales correlation to the target item based on the correlation values of each of the one or more items of the other items to the target item.

19. The computing device of claim 7, wherein calculating the weighting factor for each of the one or more of the other items comprises calculating the weighting factor for each of the one or more of the other items based on the correlation values of each of the one or more items of the other items to the target item and based on a volume factor for each of the one or more of the other items, wherein the volume factor is representative of the difference between a sales volume for each of the one or more of the other items and a sales volume of the target item.

20. A computer-readable storage medium that includes instructions that, if executed by a computing device having one or more processors, cause the computing device to perform operations that include:
for each item of a plurality of items sold by a retailer, estimating non-promotional sales volume of the item during a period of time including a sales promotion for the item based on sales data for the item during the period of time;
correlating the non-promotional sales for each item of the plurality of items to one another;
categorizing one or more items of the plurality of items as similar to a select item of the plurality of items based on the correlation of the non-promotional sales of the one or more similar items to the non-promotional sales of the select item;
estimating baseline sales of the select item during the period of time based on the non-promotional sales for each of the one or more similar items; and
calculating a sales lift for the select item attributable to the sales promotion for the select item based on actual sales data for the select item and the estimated baseline sales of the select item during the period of time.
